(19) United States
(12) Patent Application Publication
(10) Pub. No.: US 2014/0049720 A1
(43) Pub. Date: Feb. 20, 2014

(54) BACKLIGHT UNIT AND LIQUID CRYSTAL DISPLAY INCLUDING THE SAME

(71) Applicant: Min Seop Kim, Yongin-city (KR)

(72) Inventor: Min Seop Kim, Yongin-city (KR)

(21) Appl. No.: 13/914,825

(22) Filed: Jun. 11, 2013

(30) Foreign Application Priority Data
Aug. 17, 2012 (KR) 10-2012-0090049

(51) Int. Cl. F21V 8/00

(52) U.S. Cl. CPC G02B 6/0088
USPC 349/58; 362/606

(57) ABSTRACT

A liquid crystal display and a backlight unit can prevent deformation of an optical sheet. The liquid crystal display includes a light source, a light guide plate positioned to be close to the light source, an optical sheet positioned on the light guide plate and including an ear protruding on its side surface, a liquid crystal panel positioned on the optical sheet, and a receiver receiving the optical sheet, where the receiver includes a sidewall, the sidewall includes ear insertion grooves positioned to extend over the top and internal surfaces of the sidewall and to allow the ear to be inserted thereto, and the top surface of the sidewall overlaps at least a portion of the ear.

### CROSS-REFERENCE TO RELATED APPLICATIONS

This application claims priority from Korean Patent Application No. 10-2012-0090049 filed on Aug. 17, 2012 in the Korean Intellectual Property Office, the disclosure of which is incorporated herein by reference in its entirety.

### BACKGROUND

1. Field

The present disclosure relates to a liquid crystal display and a backlight unit which can prevent deformation of an optical sheet.

2. Description of the Related Technology

With the trend toward lighter and slimmer displays, including portable display devices such as notebook computers, mobile phones or portable media players (PMPs) as well as home display devices, such as TV sets or monitors, a variety of flat panel displays are widely used. There are a wide variety of flat panel displays, including a liquid crystal display device, an organic electroluminescent display device, an electrophoretic display device, and so on.

A liquid crystal display typically includes a liquid crystal panel and a light source. The liquid crystal panel includes a liquid crystal layer containing liquid crystal particles. According to the voltage applied to the liquid crystal layer, arrangement of liquid crystal particles varies, and the light transmittance of the liquid crystal layer varies accordingly. The liquid crystal display includes a plurality of pixels and may display a desired image by controlling the voltage applied to the liquid crystal layer included in each of the plurality of pixels. The liquid crystal layer included in each of the plurality of pixel areas may serve as a capacitance, sometimes referred to as a liquid crystal capacitor. Therefore, the liquid crystal display device may display a desired image by controlling the voltage applied to both ends of the liquid crystal capacitor. The light source supplies light to the liquid crystal panel and the liquid crystal panel may display an image by adjusting the transmittance of the light supplied from the light source. The liquid crystal display may further include a light guide plate. The light guide plate may evenly distribute the light supplied from the light source to the liquid crystal panel. The liquid crystal display may further include an optical sheet between the light guide plate and the liquid crystal panel. The optical sheet may control optical properties of the light supplied to the liquid crystal panel.

An optical sheet is a sheet having a relatively small thickness compared to a light guide plate and a liquid crystal panel. Such an optical sheet may shrink or expand according to humidity or temperature. When the optical sheet shrinks or expands, it may be wrinkled due to its deformation depending on the elongation ratio difference between the optical sheet and another object contacting the same, resulting in deterioration of display quality of liquid crystal display.

### SUMMARY OF CERTAIN INVENTIVE ASPECTS

Embodiments of the present invention provide a liquid crystal display and a backlight unit which can prevent deformation of an optical sheet.

Embodiments also provide a liquid crystal display and a backlight unit which can improve display quality of the liquid crystal display.

The above and other objects of the present invention will be described in or be apparent from the following description of certain embodiments.

According to one aspect, there is provided a liquid crystal display including a light source, a light guide plate, an optical sheet positioned on the light guide plate and including an ear protruding on a side surface of the optical sheet, a liquid crystal panel on the optical sheet, and a receiver configured to receive the optical sheet, where the receiver includes a sidewall, the sidewall includes ear insertion grooves configured to extend over the top and internal surfaces of the sidewall and to allow the ear to be inserted thereto, and the top surface of the sidewall configured to overlap at least a portion of the ear.

According to another aspect, there is provided a backlight unit including a light source, a light guide, an optical sheet positioned on the light guide plate and including an ear protruding on its side surface, a liquid crystal panel positioned on the optical sheet, and a receiver configured to receive the optical sheet, where the receiver includes a sidewall, the sidewall includes ear insertion grooves extending over the top and internal surfaces of the sidewall and allowing the ear to be inserted thereto, and the top surface of the sidewall overlaps at least a portion of the ear.

Embodiments of the present invention provide at least the following effects and advantages.

First, even if the temperature or humidity changes, the optical sheet can be prevented from being wrinkled.

Next, a receiver which can easily and firmly receive the optical sheet may be provided.

### BRIEF DESCRIPTION OF THE DRAWINGS

The above and other features and advantages of the present invention will become more apparent by describing in detail certain embodiments thereof with reference to the attached drawings in which:

FIG. 1 is an exploded perspective view of a liquid crystal display according to an embodiment of the present invention;

FIG. 2 is a plan view illustrating a receiver and an optical sheet according to an embodiment of the present invention connected to each other;

FIG. 3 is a cross-sectional view taken along line III-III′ in FIG. 2;

FIG. 4 is a plan view illustrating a receiver and an optical sheet according to another embodiment of the present invention connected to each other;

FIG. 5 is a cross-sectional view taken along line V-V′ in FIG. 4;

FIG. 6 is a plan view illustrating a receiver and an optical sheet according to still another embodiment of the present invention connected to each other;

FIG. 7 is a cross-sectional view taken along the line VII-VII′ in FIG. 6;

FIG. 8 is an enlarged view of a region VIII in FIG. 7;

FIG. 9 is a plan view illustrating a receiver and an optical sheet according to still another embodiment of the present invention connected to each other; and

FIG. 10 is a cross-sectional view taken along the line X-X′ in FIG. 9.

### DETAILED DESCRIPTION OF CERTAIN INVENTIVE EMBODIMENTS

Advantages and features of the present invention and methods of accomplishing the same may be understood more readily by reference to the following detailed description of certain embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will be defined by the appended claims. Thus, in some embodiments, well-known structures and devices are not shown in order not to obscure the description of the invention with unnecessary detail. Like numbers generally refer to like elements throughout. In the drawings, the thickness of layers and regions may be exaggerated for clarity.

It will be understood that when an element or layer is referred to as being “on,” or “connected to” another element or layer, it can be directly on or connected to the other element or layer or intervening elements or layers may be present. In contrast, when an element is referred to as being “directly on” or “directly connected to” another element or layer, there are no intervening elements or layers present. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present invention.

Spatially relative terms, such as “below,” “beneath,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

Embodiments described herein will be described referring to plan views and/or cross-sectional views by way of ideal schematic views of the invention. Accordingly, the views may be modified depending on manufacturing technologies and/or tolerances. Therefore, the embodiments of the invention are not limited to those shown in the views, but include modifications in configuration formed on the basis of manufacturing processes. Therefore, regions exemplified in figures have schematic properties and shapes of regions shown in figures exemplify specific shapes of regions of elements and not limit aspects of the invention.

Hereinafter, embodiments of the present invention will be described in further detail with reference to the accompanying drawings.

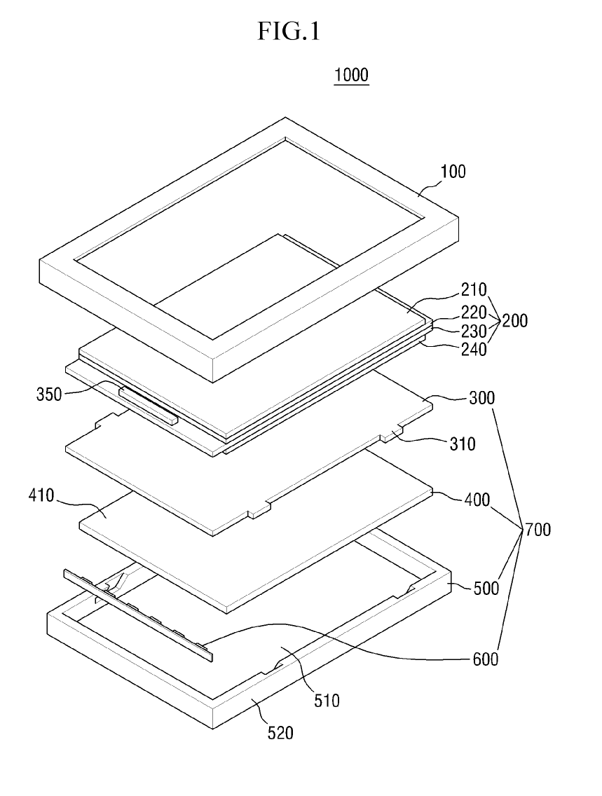

FIG. 1 is an exploded perspective view of a liquid crystal display according to an embodiment of the present invention.

Referring to FIG. 1, the liquid crystal display 1000 includes a liquid crystal panel 200, an optical sheet 300, a light guide plate 400, a receiver 500 and a light source 600.

The liquid crystal panel 200 is positioned on the optical sheet 300. The light emitted from the light source 600 may pass the liquid crystal panel 200 through the light guide plate 400 and the optical sheet 300. The liquid crystal panel 200 controls the transmittance of the light passing the liquid crystal panel 200, thereby displaying a desired image.

The liquid crystal panel 200 may include a first polarizing plate 210, a first substrate 220, a second substrate 230, and a second polarizing plate 240.

A liquid crystal layer (not shown) may be interposed between the first substrate 220 and the second substrate 230, and the liquid crystal panel 200 may control arrangement of liquid crystal particles contained in the liquid crystal layer to control the light transmittance of the liquid crystal panel 200.

The liquid crystal panel 200 may further include a driving element 350 for driving the liquid crystal panel 200. The driving element 350 may be positioned on the second substrate 230. According to some embodiments, the driving element 350 may be connected to the second substrate 230 through a flexible circuit board.

The optical sheet 300 may be positioned on a top surface 410 of the light guide plate 400. The optical sheet 300 may control optical properties of the light supplied to the liquid crystal panel 200. The optical sheet 300 may include, for example, a diffusion film, a phase difference film or a retardation film, a reflective polarization film and so on, but not limited thereto.

The optical sheet 300 may include an ear 310 protruding on a side surface of the optical sheet 300. The ear 310 may have a hexahedral shape, but not limited thereto. When the optical sheet 300 is received in the receiver 500, the ear 310 may fasten the receiver 500 and the optical sheet 300 to each other, as described below.

The light guide plate 400 may be positioned under the optical sheet 300. The light guide plate 400 may be positioned close to the light source 600. While FIG. 1 shows that one side surface of the light guide plate 400 is close to the light source 600, multiple side surfaces of the light guide plate 400 may be close to the light source 600 or a bottom surface of the light guide plate 400 may be close to the light source 600 according to the position of the light source 600. The light guide plate 400 evenly distributes the light supplied from the light source 600 and emits the same to the top surface 410 of the light guide plate 400.

The receiver 500 may include a bottom surface 510 and a sidewall 520. The sidewall 520 may upwardly extend along the perimeter of the bottom surface 510. The sidewall 520 may be coupled to the optical sheet 300 to receive the optical sheet 300. According to some embodiments, a region of the sidewall 520 coupled to the optical sheet 300 may be formed of a separate mold frame separable from the other region of the receiver 500.

The receiver 500 may receive the optical sheet 300, the light guide plate 400 and the light source 600 inside the sidewall 520.

The light source 600 may be positioned close to the light guide plate 400. While FIG. 1 shows that the light source 600 is positioned close to one side surface of the light guide plate 400, the light source 600 may be positioned to close to multiple side surfaces of the light guide plate 400 according to embodiments and may be positioned close to the bottom surface of the light guide plate 400. The light source 600 may be a light emitting diode (LED) or a cold cathode fluorescent lamp (CCFL), but not limited thereto. Rather, a variety of light generating devices capable of generating light may be used as the light source 600.

According to some embodiments, the optical sheet 300, the light guide plate 400, the receiver 500 and the light source 600 may constitute a backlight unit 700.

The liquid crystal display 1000 may further include a top cover 100. The top cover 100 may form an external appearance of top and lateral surfaces of the liquid crystal display 1000. The top cover 100 may be positioned on a top portion of the liquid crystal panel 200. According to some embodiments, the top cover 100 may be formed to have the same height as the top portion of the liquid crystal panel 200.

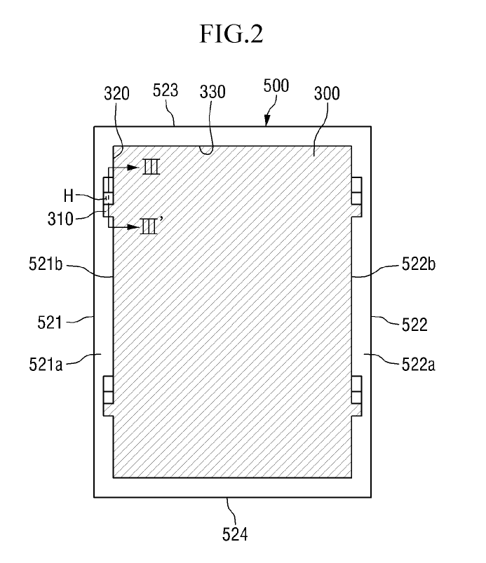

Hereinafter, a state in which the optical sheet 300 and the receiver 500 according to an embodiment of the present invention are connected to each other will be described in more detail with reference to FIG. 2 receiver

Referring to FIG. 2, the sidewall 520 may include first to fourth sidewalls 521, 522, 523 and 524. The first sidewall 521 and the second sidewall 522 may be positioned to face each other, and the third sidewall 523 and the fourth sidewall 524 may be positioned to face each other. The third sidewall 523 and the fourth sidewall 524 may be perpendicular to the first sidewall 521 and the second sidewall 522, respectively.

The first sidewall 521 includes ear insertion grooves H positioned to extend over the top surface 521a and the internal surface 521b of the first sidewall 521. The ear 310 is inserted to the guide grooves H. At least a portion of the ear 310 may be positioned to overlap the top surface 521a of the first sidewall 521. If at least a portion of the ear 310 is positioned to overlap the top surface 521a of the first sidewall 521, it is possible to prevent the optical sheet 300 from being deviated to a top portion of the receiver 500 with separate components adhered to the optical sheet 300. Since the liquid crystal display 1000 and the backlight unit 700 may not include separate components adhered to the optical sheet 300, deformation of the optical sheet 400 can be prevented due to an elongation ratio difference between the optical sheet 400 and another component adhered to the optical sheet 400. While FIG. 2 shows that each two of the ear insertion grooves H are formed on the first sidewall 521 and the second sidewall 522, the locations and numbers of the ear insertion grooves H may vary in many ways according to different embodiments. The locations and number of the ear 310 may also vary according to the locations and number of the ear insertion grooves H. The optical sheet 300 may also not include the ear 310 at a location at least not corresponding to the ear insertion groove H.

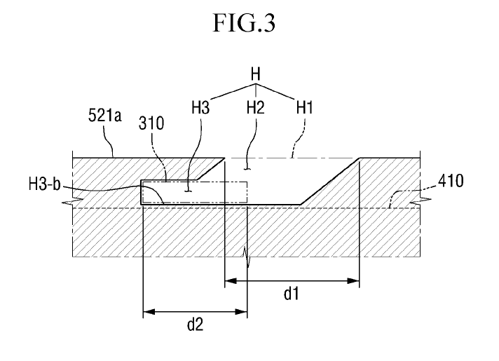

Hereinafter, the ear insertion grooves H will be described in more detail with reference to FIG. 3. FIG. 3 is a cross-sectional view taken along the line III-III′ in FIG. 2.

Each of the ear insertion grooves H may include an entrance H1, a connector H2 and a mounter H3. The entrance H1 may be positioned on the top surface 521a of the first sidewall 521. The ear 310 may be inserted into the ear insertion groove H through the entrance H1. A width d1 of the entrance H1 may be greater than or equal to a width d2 of the ear 310 in a direction perpendicular to a direction in which the ear 310 protrudes. If the width d1 is greater than or equal to the width d2, deformation of the ear 310 can be prevented when the ear 310 is inserted into the ear insertion groove H through the entrance H1. According to some embodiments, the width d1 of the entrance H1 may be smaller than or equal to a width d2.

The ear 310 may be positioned on the mounter H3. At least a portion of the top surface of the mounter H3 may be covered by the top surface 521a of the first sidewall 521. Therefore, a top surface of the optical sheet 400 may be positioned to be lower than the top surface 521a of the first sidewall 521. A bottom surface H3-b of the mounter H3 may be parallel with the top surface 410 of the light guide plate 400. If the bottom surface H3-b of the mounter H3 is parallel with the top surface 410 of the light guide plate 400, the optical sheet 400 may be arranged to be parallel with the top surface 410 of the light guide plate 400.

The connector H2 may connect the mounter H3 to the entrance H1. The connector H2 may be tilted with respect to the bottom surface H3-b of the mounter H3. A horizontal width of the connector H2 may be greater than or equal to the width d2 of the ear 310 in the direction perpendicular to the direction in which the ear 310 protrudes. If the horizontal width of the connector H2 is greater than or equal to the width d2 of the ear 310, deformation of the ear 310 can be prevented when the ear 310 is inserted into the ear insertion groove H.

Referring again to FIG. 2, the optical sheet 300 may include a first side surface 320 and a second side surface 330. The first side surface 320 may face the first sidewall 521, and the ear 310 may be positioned on the first side surface 320.

The second side surface 330 may be substantially perpendicular to the first side surface 320. The ear 310 may not be positioned on the second side surface 330. The second side surface 330 may face the second sidewall 522. The second side surface 330 and the second sidewall 522 may make close contact with each other. If the second side surface 330 and the second sidewall 522 make close contact with each other, they are inserted into the ear insertion grooves H, thereby preventing the optical sheet 300 received in the receiver 500 from moving.

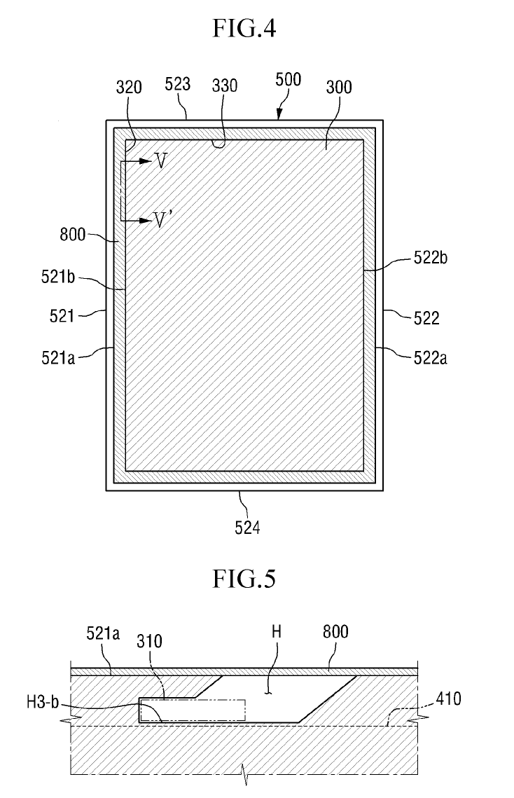

Hereinafter, still another embodiment of the present invention will be described with reference to FIGS. 4 and 5. FIG. 4 is a plan view illustrating a state in which a receiver and an optical sheet according to another embodiment of the present invention are connected to each other and FIG. 5 is a cross-sectional view taken along the line V-V′ in FIG. 4.

Referring to FIGS. 4 and 5, a liquid crystal display 1000 or a backlight unit 700 may further include a separation preventer 800. The separation preventer 800 may be a tape or film having one surface applied with an adhesive material. The separation preventer 800 may be positioned on a top surface of the sidewall 520. The separation preventer 800 may cover the entrance H1 of the ear insertion groove H. The separation preventer 800 may prevent the ear 310 from being separated from the ear insertion groove H by covering the entrance H1 of the ear insertion groove H. The separation preventer 800 may be spaced apart from the ear 310. In such a case, even if the optical sheet 300 shrinks or expands due to a change in humidity and/or temperature, deformation of the optical sheet 300 can be prevented due to an elongation ratio difference between the separation preventer 800 and the optical sheet 300.

The separation preventer 800 may be positioned along the top surface of the sidewall 520. The separation preventer 800 may prevent light leakage from occurring from a lower portion of the optical sheet 300. According to some embodiments, the separation preventer 800 may be formed of a double-sided tape to attach the backlight unit 700 and the liquid crystal panel 200 to each other.

While FIG. 4 shows that the separation preventer 800 is positioned along the top surface of the sidewall 520, the separation preventer 800 may include a plurality of separation preventers according to some embodiments and may be spaced apart from each other on the ear insertion grooves H.

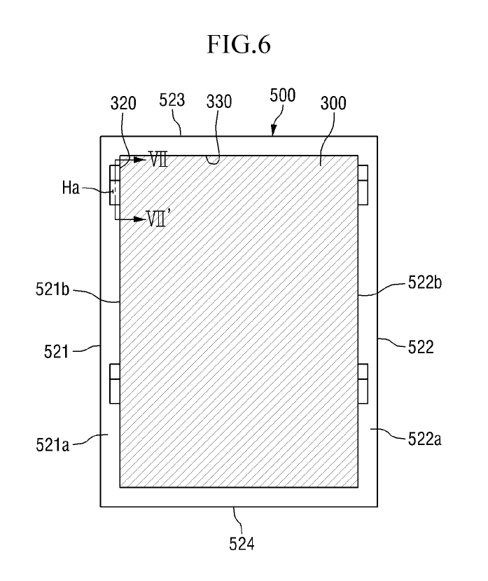

Hereinafter, still another embodiment of the present invention will be described with reference to FIGS. 6 and 7. FIG. 6 is a plan view illustrating a state in which a receiver and an optical sheet according to still another embodiment of the present invention are connected to each other and FIG. 7 is a cross-sectional view taken along the line VII-VII′ in FIG. 6.

Referring to FIGS. 6 and 7, the ear 310 may completely overlap the top surface of the sidewall 520. The ear 310 may completely overlap the first sidewall 521 of the sidewall 520, which is a sidewall having the ear insertion groove Ha formed thereon, and top surfaces 521a and 522a of the second sidewall 522. The ear 310 is inserted into the ear insertion groove Ha so as not to be exposed to the first sidewall 521 and the top surfaces 521a and 522a of the second sidewall 522.

The ear insertion groove Ha may include an entrance Ha1, a connector Ha2 and a mounter Ha3. The entrance Ha1 may be positioned on the top surface 521a of the first sidewall 521. The ear 310 may be inserted into the ear insertion groove Ha through the entrance H1. A width d3 of the entrance H1a may be greater than or equal to the width d2 of the ear 310 in the direction perpendicular to the direction in which the ear 310 protrudes. If the width d3 of the entrance H1a is greater than or equal to the width d2 of the ear 310, deformation of the ear 310 can be prevented when the ear 310 is inserted into the ear insertion groove Ha through the entrance Ha1. According to some embodiments, the width d3 of the entrance H1a may be smaller than or equal to the width d2 of the ear 310.

The ear 310 may be positioned on the mounter Ha3. At least a portion of the top surface of the mounter Ha3 may be covered by the top surface 521a of the first sidewall 521. In particular, a top portion of a region of the mounter Ha3 where the ear 310 is positioned may be completely covered by the top surface 521a of the first sidewall 521. To this end, the mounter Ha3 may horizontally extend farther from the entrance Ha1 than from the mounter H3 in FIG. 3. A bottom surface Ha3-b of the mounter Ha3 may be parallel with the top surface 410 of the light guide plate 400. If the bottom surface Ha3-b of the mounter Ha3 is parallel with the top surface 410 of the light guide plate 400, the optical sheet 400 may be arranged to be parallel with the top surface 410 of the light guide plate 400.

The connector Ha2 may connect the mounter Ha3 to the entrance Ha1. The connector Ha2 may be tilted with respect to the bottom surface Ha3-b of the mounter Ha3. A horizontal width of the connector Ha2 may be greater than or equal to the width d2 of the ear 310 in the direction perpendicular to the direction in which the ear 310 protrudes. If the horizontal width of the connector Ha2 is greater than or equal to the width d2 of the ear 310, deformation of the ear 310 can be prevented when the ear 310 is inserted into the ear insertion groove Ha.

The first sidewall 521 may further include a stopper P. The stopper P may be positioned on the ear insertion groove Ha. The stopper P may protrude toward the inside of the ear insertion groove Ha from the wall of the ear insertion groove Ha. While FIG. 7 shows that the stopper P is positioned on a top surface Ha3-t of the mounter Ha3, but not limited thereto. According to some embodiments, the stopper P may be positioned on a bottom surface Ha3-b of the mounter Ha3. The stopper P may prevent the ear 310 positioned on the mounter Ha3 from being deviated from the mounter Ha3.

While FIG. 6 shows that each two of the ear insertion groove Ha are formed on the first sidewall 521 and the second sidewall 522, the locations and numbers of the ear insertion grooves Ha may vary in many ways according to different embodiments. The locations and number of the ear 310 may vary according to the locations and number of the ear insertion grooves Ha. The optical sheet 300 may also not include the ear 310 at a location at least not corresponding to the ear insertion groove Ha.

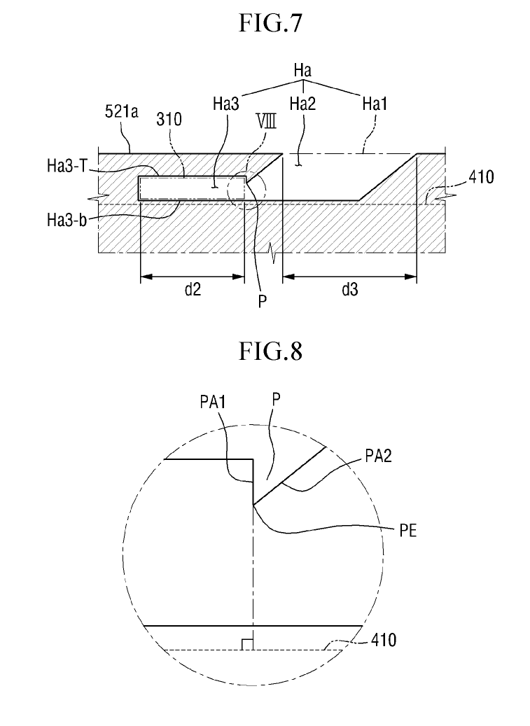

Hereinafter, the stopper P will be described in more detail with reference to FIG. 8. FIG. 8 is an enlarged view of a region VIII in FIG. 7.

Referring to FIG. 8, the stopper P may include a peak PE, an internal surface PA1 and an external surface PA2. The peak PE may be a region of the stopper P protruding most. In FIG. 8, the peak PE has a sharp-ended shape. However, according to some embodiments, the peak PE may have a planar or curved surface.

The internal surface PA1 is a surface positioned opposite to the entrance Ha1 from the peak PE. The internal surface PA1 may be perpendicular to the top surface 410 of the light guide plate 400. If the internal surface PA1 is perpendicular to the top surface 410, it is possible to easily prevent the ear 310 from being deviated from the mounter Ha3.

The external surface PA2 is a surface positioned toward the entrance Ha1 from the peak PE. The external surface PA2 may be tilted with respect to the top surface of the light guide plate 400. If the external surface PA2 is tilted with respect to the top surface of the light guide plate 400, the ear 310 can be easily inserted into the mounter Ha3.

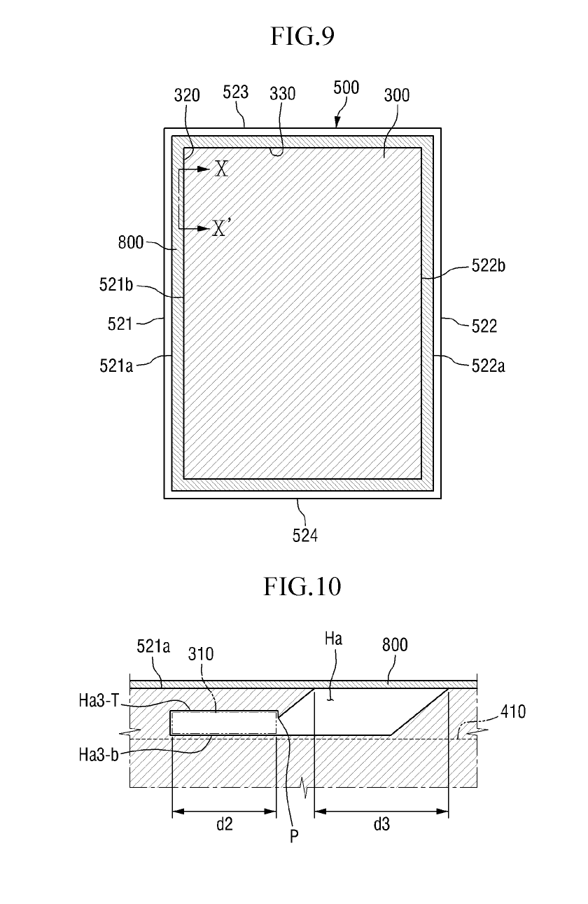

Hereinafter, still another embodiment of the present invention will be described with reference to FIGS. 9 and 10. FIG. 9 is a plan view illustrating a state in which a receiver and an optical sheet according to still another embodiment of the present invention are connected to each other, and FIG. 10 is a cross-sectional view taken along the line X-X′ in FIG. 9.

Referring to FIGS. 9 and 10, a liquid crystal display 1000 or a backlight unit 700 may further include a separation preventer 800. The separation preventer 800 may cover the entrance Ha1 of the ear insertion groove Ha. The separation preventer 800 may prevent the ear 310 from being separated from the ear insertion groove Ha by covering the entrance Ha1 of the ear insertion groove Ha. The separation preventer 800 may be spaced apart from the ear 310. In such a case, even if the optical sheet 300 shrinks or expands due to a change in humidity and/or temperature, deformation of the optical sheet 300 can be prevented due to an elongation ratio difference between the separation preventer 800 and the optical sheet 300.

While FIG. 9 shows that the separation preventer 800 is positioned along the top surface of the sidewall 520, the separation preventer 800 may include a plurality of separation preventers according to some embodiments and may be spaced apart from each other on the ear insertion grooves Ha.

While the present invention has been particularly shown and described with reference to certain embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A liquid crystal display comprising:
a light source;
a light guide plate;
an optical sheet positioned on the light guide plate and including an ear protruding on a side surface of the optical sheet;
a liquid crystal panel on the optical sheet; and
a receiver configured to receive the optical sheet,
wherein the receiver includes a sidewall, the sidewall includes ear insertion grooves configured to extend over a top and internal surfaces of the sidewall and to allow the ear to be inserted thereto, and the top surface of the sidewall configured to overlap at least a portion of the ear.

2. The liquid crystal display of claim 1, wherein each of the ear insertion grooves includes an entrance on the top surface of the sidewall, a separation preventer on the top surface of the sidewall and covering the entrance, and wherein the ear and the separation preventer are configured to not contact each other.

3. The liquid crystal display of claim 1, wherein the ear insertion groove further includes an entrance positioned on the top surface of the sidewall, a mounter having the ear positioned thereon, and a connector configured to connect the entrance and the mounting groove to one another.

4. The liquid crystal display of claim 3, wherein the entrance and at least a portion of the mounting groove are configured to not overlap each other.

5. The liquid crystal display of claim 3, wherein a bottom surface of the mounting groove is parallel with a top surface of the light guide plate.

6. The liquid crystal display of claim 3, wherein the ear is not exposed through the entrance.

7. The liquid crystal display of claim 6, wherein the sidewall further includes a stopper protruding toward the inside of the ear insertion groove and positioned closer to the entrance than to the ear.

8. The liquid crystal display of claim 7, wherein the stopper includes a peak, an internal surface positioned opposite to the entrance from the peak, and an external surface positioned toward the entrance from the peak, the internal surface being perpendicular to the top surface of the light guide plate.

9. The liquid crystal display of claim 1, wherein the optical sheet further includes a first side surface having the ear positioned thereon, and a second side surface perpendicular to the first side surface and not having the ear positioned thereon.

10. The liquid crystal display of claim 9, wherein, the sidewall includes a first sidewall having the ear insertion grooves positioned thereon, and a second sidewall perpendicular to the first sidewall, the second side surface and the second sidewall contacting each other.

11. A backlight unit comprising:
a light source;
a light guide plate;
an optical sheet positioned on the light guide plate and including an ear protruding on its side surface; and
a receiver configured to receive the optical sheet,
wherein the receiver includes a sidewall, the sidewall includes ear insertion grooves extending over the top and internal surfaces of the sidewall and allowing the ear to be inserted thereto, and the top surface of the sidewall overlaps at least a portion of the ear.

12. The backlight unit of claim 11, wherein each of the ear insertion grooves includes an entrance on the top surface of the sidewall, a separation preventer on the top surface of the sidewall and covering the entrance, and the ear and the separation preventer are configured to not contact with each other.

13. The backlight unit of claim 11, wherein the ear insertion groove further includes an entrance on the top surface of the sidewall, a mounter having the ear positioned thereon, and a connector connecting the entrance and the mounting groove.

14. The backlight unit of claim 13, wherein the entrance and at least a portion of the mounting groove do not overlap each other.

15. The backlight unit of claim 13, wherein a bottom surface of the mounting groove is parallel with a top surface of the light guide plate.

16. The backlight unit of claim 13, wherein the ear is not exposed through the entrance.

17. The backlight unit of claim 16, wherein the sidewall further includes a stopper protruding toward the inside of the ear insertion groove and positioned closer to the entrance than to the ear.

18. The backlight unit of claim 17, wherein the stopper includes a peak, an internal surface opposite to the entrance from the peak, and an external surface toward the entrance from the peak, the internal surface being perpendicular to the top surface of the light guide plate.

19. The backlight unit of claim 11, wherein the optical sheet further includes a first side surface having the ear positioned thereon, and a second side surface perpendicular to the first side surface and not having the ear positioned thereon.

20. The backlight unit of claim 10, wherein the sidewall includes a first sidewall having the ear insertion grooves positioned thereon, and a second sidewall perpendicular to the first sidewall, the second side surface and the second sidewall making close contact with each other.
